(19) United States
(12) Patent Application Publication
(10) Pub. No.: US 2023/0145726 A1
(43) Pub. Date: May 11, 2023

(54) METHOD AND APPARATUS FOR MAKING A CORRUGATED ZONE TO A DRINKING STRAW

(71) Applicant: DOLEA OY, Helsinki (FI)

(72) Inventors: Mika SALOMÄKI, Hyvinkää (FI); Markku SALOMÄKI, Hyvinkää (FI)

(73) Assignee: DOLEA OY, Helsinki (FI)

(21) Appl. No.: 17/911,880

(22) PCT Filed: Mar. 15, 2020
(86) PCT No.: PCT/FI2020/050161

§ 371 Date: Sep. 15, 2022

(51) Int. Cl. B31D 5/04; B31D 5/00; A47G 21/18

(52) U.S. Cl. CPC B31D 5/04; A47G 21/186; B31D 5/0095

(57) ABSTRACT

Method and apparatus for making a corrugated zone to a bendable drinking straw. The drinking straw is made of a web that is moved along a guided path in a wanted speed and the corrugated zone is created by clamping the web with a clamping mechanism against the guided path for a wanted period of time to stop the motion of the second part of the web after the clamping mechanism.

### FIELD

The aspects of the disclosed embodiments relate to a method and an apparatus for making a corrugated zone to a drinking straw.

### BACKGROUND

In prior art technology flexible straws with a corrugated zone for bending a straw have been manufactured so that single straws that have been cut to their final length are directed into trays that comprise individual slots for each single straw. A pin with rings formed onto its periphery is then inserted into each straw and the straws are moved by the help of the pins into clamping mechanism that has two jaws. The jaws are clamped around the straw at the location where the zone with rings is so that a corrugated zone is created into the straw. During clamping the straw is stationary on the pin. This method is suitable for plastic straws but not good, for example, for paper straws. In addition, the clamping is an additional phase of work that degrades the manufacturing capacity and also needs a more structure.

### SUMMARY

The aspects of the disclosed embodiments is are directed to eliminating the drawbacks described above and to achieve a reliable, economical, simple and efficient method and apparatus for making a corrugated zone to a drinking straw. The method according to the aspects of the disclosed embodiments for making a corrugated zone to a drinking straw is presented in the claims. Correspondingly, an apparatus according to the aspects of the disclosed embodiments for making a corrugated zone to a drinking straw is characterized by what is presented in the claims. Other embodiments of the present disclosure are characterized by what is presented in the other claims.

An aspect of the disclosed embodiments is to provide a method for making a corrugated zone to a bendable drinking straw. Advantageously, the drinking straw is made of a web that is moved along a guided path in a wanted speed and the corrugated zone is created by clamping the web at a location towards the guided path for a wanted period of time and allowing a first part of the web before the clamping location to move whereas the motion of the second part of the web after the clamping location is stopped.

Another aspect of the disclosed embodiments is to provide an apparatus for making a corrugated zone to a bendable drinking straw, that is arranged to be formed of a sheet-like web that has a first part and a second part. Advantageously the apparatus comprises a guiding element around which the web is arranged to be enfolded and along which the enfolded web is arranged to be moved, and that the apparatus comprises a clamping mechanism between the first part and the second part to clamp the moving web to the guiding element.

The method and apparatus according to the aspects of the disclosed embodiments, later the solution according to the present dislcosure, has significant advantages over the solutions of the prior art. For instance, the clamping of the corrugated zone does not degrade substantially the manufacturing speed. One advantage is that the manufacturing method suits paper straws well. Yet a further advantage is that the apparatus is simple in its structure and small in its size. One further advantage is that the solution according to the present disclosure can be easily installed into existing machines that make straight drinking straws.

### BRIEF DESCRIPTION OF THE DRAWINGS

In the following, the aspects of the disclosed embodiments will be described in detail by the aid of examples by referring to the attached simplified and diagrammatic drawings, wherein

FIG. 1 presents an upper part of a corrugated drinking straw,

FIG. 2 presents in a side view a manufacturing process of the corrugated drinking straws according to the present disclosure,

FIG. 3 presents in a top view a manufacturing process of the corrugated drinking straws according to the present disclosure,

FIG. 4 presents in cross-section A-A of FIG. 2 an enlarged detail of a clamping mechanism according to the present disclosure,

FIG. 5 presents in a top view a manufacturing process of the corrugated drinking straws according to the present disclosure in the situation where the clamping mechanism is not activated, and

FIG. 6 presents in a top view a manufacturing process of the corrugated drinking straws according to the present disclosure in the situation where the clamping mechanism is activated.

### DETAILED DESCRIPTION OF THE DISCLOSED EMBODIMENTS

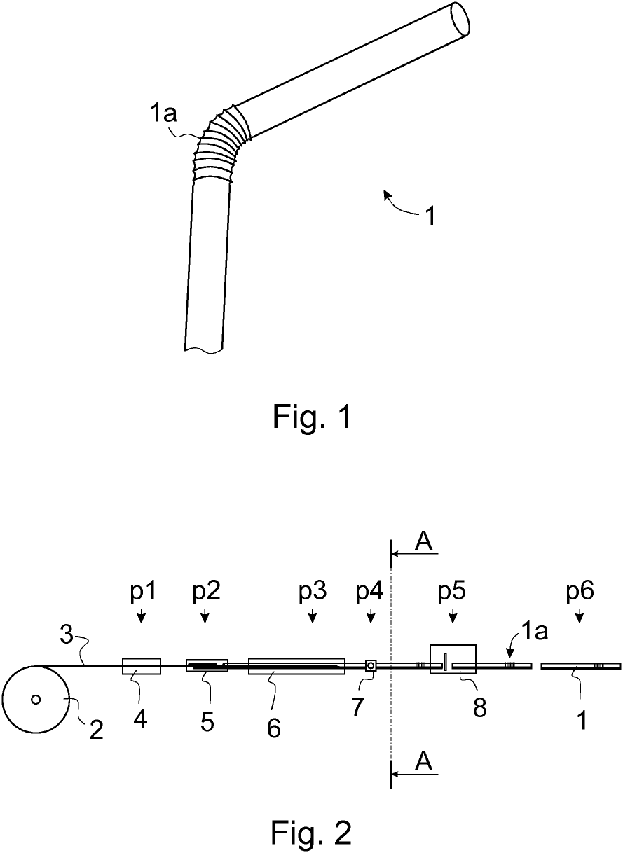

FIG. 1 presents an upper part of a corrugated drinking straw 1 which comprises a corrugated zone 1a that makes it possible to bend the straw. Advantageously, the corrugated drinking straw 1 according to the present disclosure is made of substantially sheet-like cardboard material which is cut preferably from a coated continuous cardboard web. Preferably, the cross-section of the drinking straw 1 is substantially round but the cross-sectional shape may also be other than a circular shape.

The coated cardboard used for the drinking straw according to the present disclosure is sustainable environment-friendly cardboard utilized also e.g. in paper cups. In the most preferable embodiment, the cardboard coating is made online with cardboard manufacturing process using dispersion techniques. The coating layer is very thin comprising much less plastic than e.g. conventional PE/PLA coated cardboards. This material is easy to recycle with other paper-products and the material is repulpable. This coated cardboard is also biodegradable and degrades in marine environments easily. This coated cardboard is also heatsealable providing the drinking straw manufacturing without additional components, such as adhesives or glues.

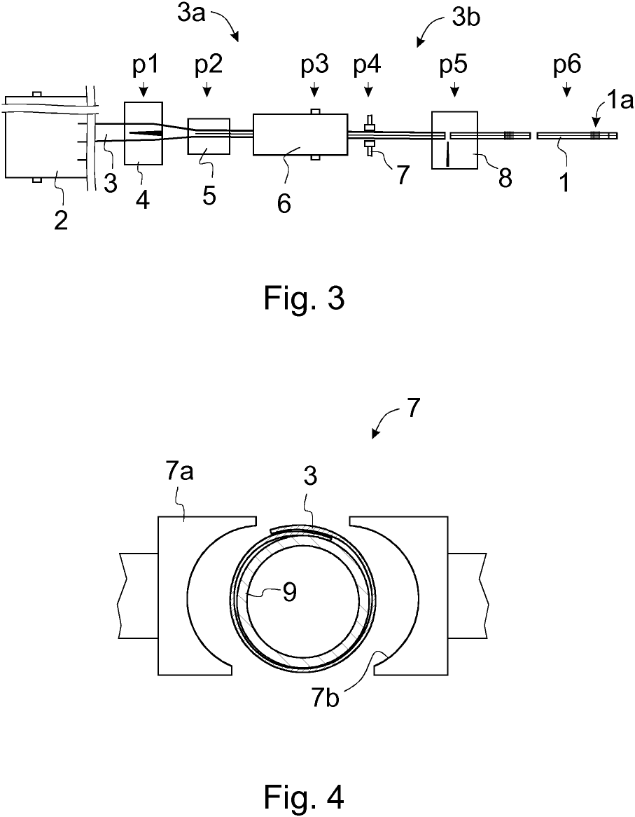

FIGS. 2 and 3 present a manufacturing apparatus and process of the corrugated drinking straw 1 according to the present disclosure. FIG. 2 presents the manufacturing apparatus and process in a side view and FIG. 3 presents the manufacturing apparatus and process in a top view. The main phases of the manufacturing process are a bending phase p1 with a bending means 4, a form creating phase p2 with a mold means 5, a fastening phase p3 with a fastening means 6, a clamping phase p4 a clamping mechanism 7, a cutting phase p5 with a cutting mechanism 8 and finalizing phase p6.

The coated cardboard material, which may be preprinted, is rolled out from a material roll 2. The out-rolled material forms a continuous, substantially narrow and thin web 3. The width of the web 3 depends on the diameter of the straw 1 to be made. The out-rolled material is called web 3 as long as the straw 1 is cut off from the web. The web 3 is divided into two main parts called a first part 3a of the web 3 which first part 3a extends from the roll 2 up to the clamping mechanism 7, and a second part 3b of the web 3 which second part 3b extends from the clamping mechanism 7 up to the cutting mechanism 8.

The motion of the web 3 is achieved by the help of a conveying mechanism that is not presented in figures. The conveying mechanism may be, for example, a conveyor belt that is pressed towards web 3. The conveying mechanism may comprise one or more closed belt loops that are in contact with the web 3 substantially during all the phases from phase p1 to phase p6. Some phases, for example the clamping phase p4 and the cutting phase p5 may require that the conveyor belt is not in their way at those locations.

In phase p1, the web 3 is moved forward and simultaneously bent with a bending means 4 in a shape of the drinking straw. When making straws 1 with a circular cross-section the sheet-like web 3 is preferably bent around a circular guiding element 9 that forms a guided path for the web 3. The guiding element 9 may be a pipe or bar or alike along which the web 3 is moved forward. The guiding element 9 is a substantially straight structure extending substantially from the beginning area of the first part 3a of the web 3 substantially to the end of the second part 3b of the web 3, ending before the cutting mechanism 8. For the clarity, the guiding element 9 is presented only in FIGS. 4-6.

In phase p2, the liquid channel is formed with a mold means 5. When making round straws 1 the cross-section of the web 3 is substantially circular and the web 3 is moving forward along the guiding element 9. Thus, the guiding element 9 is enfolded by the moving web 3.

In phase p3, the overlapped edges of the web 3 are fastened to each other with a fastening means 6 forming an edge section of the drinking straw 1. When the edge section is formed, also the liquid channel is formed alongside or adjacent and essentially parallel to the edge section. In most preferable embodiment the fastening of the overlapped edges of the web 3 is made by heat sealing.

In phase p4, a corrugated zone 1a is formed. For creating the corrugated zone 1a the apparatus comprises the clamping mechanism 7 by the help of which the motion of the web 3 is momentarily halted. An enlarged detail of the clamping mechanism 7 according to the present disclosure is presented in FIG. 4 in a cross-section A-A of FIG. 2. The clamping mechanism 7 comprises preferably two similar clamping jaws 7a that are moved into opposite directions; towards the web 3 for halting the motion of the web 3 and outwards from the web 3 when allowing the motion of the web 3. The contact surface 7b of the clamping jaws 7a has preferably a substantially similar cross-sectional shape to the web 3. Together the two contact surfaces 7b preferably cover substantially the whole circumference of the web 3. In case the cross-section of the web 3 is circular also the cross-sectional shape of the contact surfaces 7b is substantially circular, advantageously semicircular or a part of it.

In phase p5 the web 3 with the corrugated zone 1a is cut to a desired length of the drinking straws 1. For that purpose the apparatus comprises a cutting mechanism 8. Preferably the cutting is made when the motion of web 3 is halted by clamping mechanism 7.

In phase p6, the drinking straw 1 is completed and it is ready for final inspection and packaging.

It is obvious, that the original material rolls 2 presented above and in the figures are wider than a single web 3. The material roll 2 is preferably cut to several parallel webs 3 to parallelly produce the drinking straws 1. It is also possible to cut the material roll 2 into a desired width of the web 3 in advance, e.g. with a preprinting process.

When at least one side of the web 3 is coated and the web 3 is bent or folded with thin water repellent coating layers facing each other, the fastening of the edge section of the drinking straws 1 can be made by heat or cold sealing. When there is no sealable coating on the material, the fastening of the edge section of the drinking straws 1 can made by food-contact approved adhesives. The heatsealing fastening method provides drinking straws 1 without additional components, like adhesives or glues.

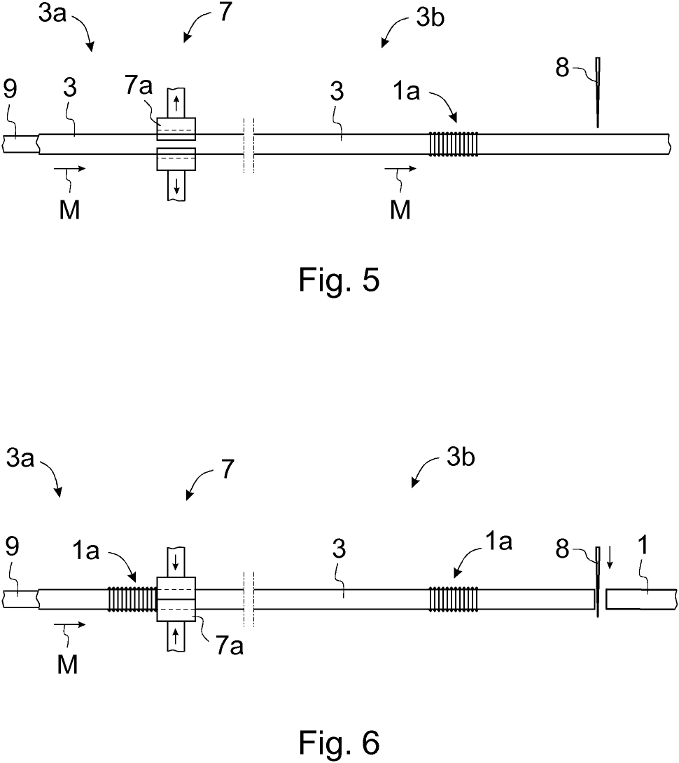

FIGS. 5 and 6 present in a top view a manufacturing process of the corrugated drinking straws 1 according to the present disclosure. FIG. 5 presents the manufacturing process in the situation where the clamping mechanism 7 is not activated, and the web 3 in its total length moves onwards in the direction of the arrow M. FIG. 6 presents the manufacturing process in the situation where the clamping mechanism 7 is activated, and the first part of the web 3 before the clamping mechanism 7 moves towards the clamping mechanism 7 in the direction of arrow M but the rest or second part of the web 3 after the clamping mechanism 7 does not move. During the short stop the first part 3a of the web 3 before the clamping mechanism 7 continues its motion but the second part 3b of the web 3 from the clamping mechanism 7 onwards is halted. The motion of the first part 3a before the clamping mechanism 7 causes a corrugation to form just in front of the clamping mechanism 7 in the direction of the motion of the web 3. The corrugated zone 1a begins to form beside the clamping mechanism 7 and develops towards opposite direction compared to the direction M of the web 3.

The web 3 may be moved at various speeds. The stopping interval and the stopping period depends on the speed of the web 3 and on a desired length of the corrugated zone 1a. Preferably the stopping interval is adjusted so that the web 3 moves between the stops a distance that corresponds to the length of the wanted drinking straw 1. In that case the straw 1 is preferably cut from web 3 when the motion of the web 3 is halted by the clamping mechanism 7.

Preferably the stopping period when the clamping mechanism 7 is activated is adjusted so that the length of the corrugated zone 1a in the completed straw will be substantially about 15-45 mm, suitably about 20-30 mm and advantageously about 22-25 mm. Thus, the maximum length of the corrugated zone 1a is substantially about 45 mm, suitably about 30 mm and advantageously about 25 mm.

It is obvious to the person skilled in the art that the present disclosure is not restricted to the examples described above but that it may be varied within the scope of the claims presented below.

It is obvious to the person skilled in the art that different embodiments of the present disclosure are not limited to the example described above, but that they may be varied within the scope of the claims presented below.

What is claimed is:

1. Method for making a corrugated zone to a bendable drinking straw, wherein the drinking straw is made of a web that is moved along a guided path in a wanted speed and the corrugated zone is created by clamping the web with a clamping mechanism against the guided path for a wanted period of time to stop the motion of the second part of the web after the clamping mechanism.

2. Method for making a corrugated zone to a bendable drinking straw, according to claim 1, wherein the clamping mechanism is kept activated during the time period in which the length of the corrugated zone develops to a wanted length.

3. Method for making a corrugated zone to a bendable drinking straw, according to claim 1, wherein the clamping mechanism is kept activated during the time period in which the length of the corrugated zone develops to a maximum of 45 mm, suitably to a maximum of 30 mm, advantageously to a maximum of 25 mm.

4. Method for making a corrugated zone to a bendable drinking straw, according to claim 1, wherein an interval for activating the clamping mechanism is adjusted so that the web moves between the activations a distance that corresponds to the length of the wanted drinking straw.

5. Method for making a corrugated zone to a bendable drinking straw, according to claim 1, wherein the drinking straw is cut from the web to its final length during the time period when the clamping mechanism is kept activated.

6. Method for making a corrugated zone to a bendable drinking straw, according to claim 1, wherein the method comprises phases as follows:
the web is taken from a roll, moved forward and simultaneously bent with a bending means in a shape of the drinking straw,
a liquid channel is formed with a mold means and the guiding element is enfolded by the moving web,
overlapped edges of the web are fastened to each other with a fastening means,
the corrugated zone is formed by the help of the clamping mechanism by the help of which the motion of the second part of the web is momentarily halted,
the web with the corrugated zone is cut to a wanted length of the drinking straws with a cutting mechanism.

7. Apparatus for making a corrugated zone to a bendable drinking straw, that is arranged to be formed of a web that has a first part and a second part, wherein the apparatus comprises a guiding element around which the web is arranged to be enfolded and along which the enfolded web is arranged to be moved, and that the apparatus comprises a clamping mechanism.

8. Apparatus for making a corrugated zone to a bendable drinking straw according to claim 7, wherein the clamping mechanism is between the first part and the second part of the web to clamp the moving web against the guiding element.

9. Apparatus for making a corrugated zone to a bendable drinking straw according to claim 7, wherein the clamping mechanism is between the first part and the second part of the web to momentarily prevent the second part of the web from moving.

10. Apparatus for making a corrugated zone to a bendable drinking straw according to claim 7, wherein the clamping mechanism is arranged to be activated at constant intervals so that the web moves between the activations a distance that corresponds to the wanted length of the drinking straw.

11. Apparatus for making a corrugated zone to a bendable drinking straw according to claim 7 above, wherein the apparatus comprises a cutting mechanism that is adjusted to cut a drinking straw from the web to its final length during the time period when the clamping mechanism is activated.

12. Apparatus for making a corrugated zone to a bendable drinking straw according to claim 7, wherein that in addition to the guiding element and the conveying mechanism the apparatus comprises in a successive order:
means for taking the web from a roll,
bending means to form a shape of the drinking straw,
mold means to form a liquid channel,
fastening means to fasten the overlapped edges of the web to each other,
the clamping mechanism to form the corrugated zone,
the cutting mechanism to cut the web to a wanted length of the drinking straws.

13. Apparatus for making a corrugated zone to a bendable drinking straw according to claim 12, wherein that conveying mechanism comprises one or more conveyor belts which are arranged to press the web against the guiding element.

14. Apparatus for making a corrugated zone to a bendable drinking straw according to claim 7, wherein that the guiding element is a substantially straight pipe or bar extending substantially from the first part of the web to the second part of the web.

15. Apparatus for making a corrugated zone to a bendable drinking straw according to claim 7, wherein the cross-section of guiding element (9) is substantially circular.
